(19) United States
(12) Patent Application Publication
(10) Pub. No.: US 2026/0087498 A1
(43) Pub. Date: Mar. 26, 2026

(54) SYSTEM AND METHOD FOR IMPLEMENTING TRANSACTION REVERSALS THROUGH ARTIFICIAL (AI) SIMULATIONS BASED ON SET THEORETIC PROPERTIES

(71) Applicant: Bank of America Corporation, Charlotte, NC (US)

(72) Inventors: Maharaj Mukherjee, Poughkeepsie, NY (US); George Albero, Charlotte, NC (US); Naga Vamsi Krishna Akkapeddi, Charlotte, NC (US); Syed Najumudeen, Hyderabad Telangana (IN)

(21) Appl. No.: 18/894,148

(22) Filed: Sep. 24, 2024

(51) Int. Cl. G06Q 20/40; G06Q 20/38

(52) U.S. Cl. CPC G06Q 20/407; G06Q 20/382; G06Q 20/4014

(57) ABSTRACT

Implementing transaction reversals through (AI) simulations based on set theoretic properties is provided. The method receives a user request including user identification of a plurality of target recipient accounts. A discrete level of trust exists between the user and each of the target recipient accounts. The method further includes receiving a user specification of a transaction. A target recipient account is auto-selected based on the level of trust. The method derives identification information from the user request. The identification information includes user identity, recipient identity, and recipient know-your-customer information. The method leverages AI to perform a simulation of the transaction. When the simulation obtains greater than a threshold of trust between the user and the recipient, the method validates the transaction and forwards the transaction to a payment gateway. When the service is not confirmed, the method reroutes the transaction from the payment gateway for transaction denial, and sends alerts.

### FIELD OF TECHNOLOGY

Aspects of the disclosure relate generally to digital transaction technology.

### BACKGROUND OF THE DISCLOSURE

Digital payments are convenient for banking customers. Specifically, digital payments enable a banking customer to transfer money instantaneously to the beneficiary without having to add/validate beneficiary account information. While digital payments make transactions faster and more convenient, digital payments have also made users more vulnerable to fraud.

Typically, fraudsters reach out to digital payment application users. Often, these fraudsters claim there are outstanding bills to be settled.

When a user responds to the fraudster that the user has already paid the bill, the fraudsters attempt to persuade the user that the transaction did not occur. And, even in the transaction is shown by the user to have occurred, the fraudster attempts to persuade the user to switch to a different payment channel. To that end, the fraudsters suggest using a specific “payment”application to ensure timely payment of allegedly unpaid bills.

Unfortunately, unsuspecting users often fall prey to this deception and end up downloading a counterfeit payment application to make payments.

Fraudsters also use fake investment schemes to victimize users. Such fake investment schemes assure doubling user returns in a short timeframe, or other such unsustainable investment outcomes. Unsuspecting investors make payments through unauthorized links. Such payments ultimately lead to the loss of the users'money.

As a general rule, fraudulent schemes allow scammers to gain remote control of the user device.

In some instances, a fraudster evokes user sympathy in order to transfer money from the user's mobile phones to the fraudster account.

The danger of fraudsters exists because users make transactions with fraudulent applications without sufficiently checking the identity of the recipient. Thus, the users fall into the trap of losing money from their account.

It would be desirable to secure user digital payment transactions.

It would be further desirable to enable retrieval of funds if the funds were mistakenly sent to the wrong person or entity.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative block diagram in accordance with principles of the disclosure.

FIG. 2 shows an illustrative apparatus that may be configured in accordance with principles of the disclosure.

FIG. 3 shows an illustrative flow diagram in accordance with principles of the disclosure.

FIG. 4 shows an illustrative flow diagram in accordance with principles of the disclosure.

FIG. 5 shows an illustrative set diagram in accordance with principles of the disclosure.

### SUMMARY OF THE DISCLOSURE

A method for implementing transaction reversals through artificial intelligence (AI) simulations based on set theoretic properties is provided. The method may include receiving a user request for a transaction. The user request may include a user identification of a target recipient account.

The method may also include receiving a user specification of a user-specified transaction involving the user and the target recipient account as well as a designation of a service to be provided by the target recipient pursuant to the transaction.

The method may derive identification information from the user-specified transaction. The identification information may include user identity, recipient identity, and recipient know-your-customer (KYC) information.

The method may also include performing the simulation—i.e., simulating the specified user transaction—using AI. When the simulation of the specified user transaction obtains greater than a threshold of trust shared between the user and the recipient, the method may validate the transaction and forward the transaction to a payment gateway. Upon confirmation of performance of the service to be provided, the method uses the payment gateway to perform the transaction.

The method may also include, when the service to be provided by the target recipient is not confirmed as having been performed within a pre-determined amount of time, rerouting the transaction from the payment gateway for transaction denial, and alerting the user and the target recipient to the transaction denial.

When the simulation of the user-specified transaction obtains less than the threshold of trust shared between the user and the recipient, the method may add a level of security to be performed prior to forwarding the transaction to the payment gateway. The level of security may also require storing the transaction in an immutable system pending satisfaction of the added level of security by the recipient.

In some embodiments the method may include formulating a token corresponding to the transaction. Then, the method may include leveraging the token to execute the transaction between a financial institution (FI) associated with the user and an FI associated with the target recipient absent any additional security measures.

The pre-determined amount of time for performance of the service may be any suitable amount. Such suitable amounts of time can include 10 minutes, 20 minutes, 30 minutes, one hour, or any suitable combination of the previously-listed amounts of time.

The method may also include using the payment gateway to perform the transaction pursuant to a plurality of terms set forth in a smart contract. In certain embodiments, the smart contract can be stored in a blockchain.

When the simulation of the specified user transaction obtains a threshold of trust that is non-zero but less than a sufficient threshold of trust sufficient to validate the transaction, the method may require satisfaction of an additional level of security prior to forwarding the transaction to, and/or executing the transaction at, the payment gateway. The additional level of security may include retrieving credit history for the target recipient.

When the simulation of the specified user transaction obtains a threshold of trust that is non-zero but less than a sufficient threshold of trust sufficient to validate the transaction, the method may require satisfaction of an additional level of security prior to forwarding the transaction to the payment gateway. The additional level of security may include retrieving account information for the target recipient.

### DETAILED DESCRIPTION OF THE DISCLOSURE

Apparatus and methods for using a mobile device for implementing transaction reversals through artificial intelligence (AI) simulations based on set theoretic properties are provided.

It is an object of the embodiments to pro-actively secure user digital payment transactions.

It is a further object of the invention to enable retrieval of funds when sent to the wrong person or entity.

Some aspects of a solution to the aforementioned problems may include one or more of the following five exemplary parts:
Authorizing the legitimacy of the receiver through AI simulations;
Establishing a trusted circle of closed entities for transaction using block chain;
Establishing token-based transaction for inter- and intra-bank trusted circle transaction;
Establishing a real-time smart contract to make/withdraw payments on one or more prescribed terms and conditions; and
Establishing a digital escrow for making safe and secure payments.

Certain embodiments include features as follows:
I. Authorizing the legitimacy of the receiver through AI simulations:
   1) The application (“app”) according to the embodiments instructs the customer to use the mobile device to enter an account and/or phone number of the receiver to initiate a funds transfer. An app can collect the information below:
   2) Receiver details like customer name, account number;
   3) It can also verify the know-your-customer (“KYC”) of the customer; and
   4) It can also find out credit history records of the recipient; and
   5) The app can also preferably shield the identity and ownership of the app, and its operation, during the whole transaction. In such embodiments, shielding may include seamless, and preferably user and/or recipient-undetectable, operation of all background checks, or similar monitoring. The shielding preferably happens in real-time—i.e., at the time of the performance of the various background checks and/or similar monitoring the shielding is being performed. In such embodiments, the shielding may protect the app from detection. Accordingly, the recipient preferably does not know that the recipient and/or the recipient information is being monitored and/or reviewed.

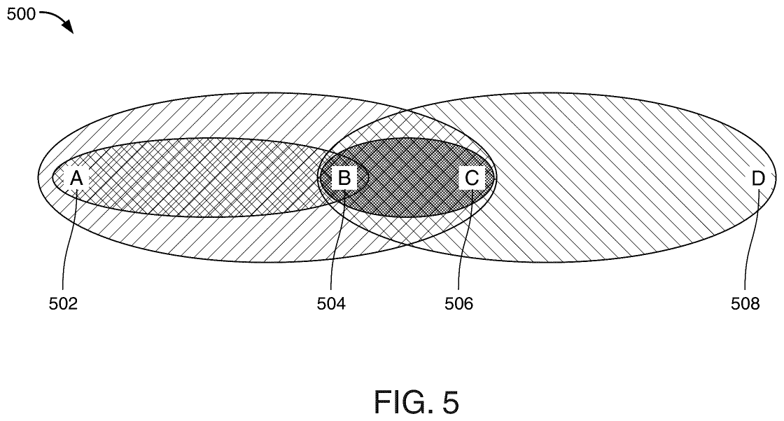

One embodiment of such shielding may require a user to pre-register for such a system of funds transfer. As part of such a pre-registration, a user and/or recipient may be required to electronically consent to background checks and monitoring by one or more FIs associated with transfers of funds provided within the system. In this way, future transfers will not require electronic consent—thereby shielding a real-time participant awareness of the performance of background checks as well as of the performance of monitoring.
2) Based on the input, the app may perform a simulation of the transaction using AI and use the simulation to verify the legitimacy of the recipient's bank account. Such a simulation may include creating a non-production environment that mirrors the relevant accounts and transaction rails. The simulation can be conducted in a digital twin. The results of the simulation may uncover heretofore unknown details about the transaction. For example, the simulation may trigger, preferably in a non-production environment, release of information about the recipient that was previously unknown.
II. Establishing a trusted circle of close entities for transaction using block chain:
   1) The app instructs the customer to use a mobile device to declare trusted accounts/clients/friends and perform one or more of the solutions listed below:
   2) Based on the list received from the trusted user, a trusted circle for the customer can be created. For the trusted circle, the system enables transaction without any authentication.
   3) By repeating the process described above (receiver details, KYC, credit history, shield identity, etc.), the system can perform all required due diligence for those untrusted transactions as well.
   4) In certain embodiments, the system can provide instructions for the trusted, as well as for the untrusted, parties. The instructions can be customized by the user. For example, a user can create a condition like, “I will reverse the recent transaction from the receiver's account if the agreed service is not provided within 30 minutes” (using a digital escrow account). See infra, Section V.
III. Establishing token-based transaction for inter-and intra-bank trusted circle transaction:
   1) The app can retrieve personal information of the sender and/or the receiver's account;
   2) App requests user permission to encrypt the personal information;
   3) App encrypts the customer's name, account, phone number; creditability of receiver's account etc., as a token;
   4) The app enables transactions based on two parties by establishing the trusted and/or tokenized transaction between inter-and intra-banks; and
   5) During an intra entity (bank) transaction, for example, a sender's account is in Bank of America® and recipient's account is in JP Morgan Bank®. The sender can validate the receiver's personal information via the common tokenization method established between trusted banks like Bank of America® and JP Morgan Chase®.
IV. Establishing Real-time Smart Contract to make/withdraw payments on terms and conditions:
   1) The app can also facilitate real-time smart contract(s) between the two parties for funds transfer; and
   2) The app can instruct the user to customize the smart contracts such that there are no payment disputes between clients.
V. Establishing Digital Escrow for making safe and secure payments:
   1) The app receives permission from the user to ensure transaction security;
   2) In the context of the application, based on the user action, the app can channel the transaction through digital escrow; and
   3) Digital escrow is a substantially immutable system which can help to protect the whole transaction from fraudsters.
VI. In the solutions set forth herein, additional embodiments are provided according to the parts described below:
   1) Establishing a trusted circle of closed entities for transaction using block chain; and
   2) Instead of a single circle of friends and trusted entities, the circle of trust may be defined using set theoretic properties (see FIG. 5, and portion of the specification corresponding thereto, below). Set theoretic properties may include defining, or otherwise limiting, how much funds can be transferred using the payment app between different sets of trusted participants. About the limits set forth using set theoretic properties, additional levels of safety features may be required to transact. Absent the additional levels of safety features, the possibility of transaction reversal may be put into place. Such a possibility of transaction reversal may need to put into place the possibility of digital escrow. Any transaction that uses the additional safety features, such as digital escrow, etc., may require consideration for same.

For the purposes of this application, set theory may be understood as follows.

In set theory, a relationship may be understood to include a connection between the elements of two sets. For example, a function can be considered a relationship between each object in its domain and the value of the object. A relation can also be a derived binary relation between two sets, such as the subset relation, also known as set inclusion.

Here are some examples of set theoretic relationships:
Membership

The fundamental binary relation between an object and a set. For example, if an object is a member of a set, the notation o∈A is used.
Subset relation

Also known as set inclusion, this relation occurs when all the members of one set are also members of another set. For example, {1, 2} is a subset of {1, 2, 3}.
Identity/equality

Two sets are identical if they have the same members as well as the same number of members.
Proper subset

A set is a proper subset of another set if it is a subset but not identical.
Power set

The set of all subsets of a given set is called the power set of that set. Sometimes, the power set of A is written as P(A).

The “trust” in FIG. 5, and the portion of the specification corresponding thereto, is not necessarily considered an “uniform” or a bi-directional relationship in the model corresponding to the embodiments. Thus, A=>B does not necessarily mean B=>A.

Another aspect of this application relates to establishing real-time smart contract usage to make/withdraw payments on specific terms and conditions.

In some embodiments, the above set-theoretic relationship can be coded using the smart contracts in a block chain.

In certain embodiments, the block chain for the inter-or intra-bank transaction can be created using a hybrid or private block chain.

Establishing digital escrow for making safe and secure payments including the following aspects. The digital escrow may establish windows of time in which the transaction is able to be consummated.

It should be noted that the solution(s) can be embedded in a mobile device as a stand-alone application or may form part of the transaction application on a mobile computing device, a stand-alone computing device, or a cloud/web-based solution. The mobile device may include a microprocessor and a memory. The mobile device may act as a payment instrument configured for transmitting and receiving electronic communications to and from another device.

The mobile device may be in electronic communication with a financial institution (“FI”) associated with the mobile device.

The mobile device may be configured to electronically communicate with a Point of Sale (“POS”) device. The mobile device may be configured to electronically communicate using a mobile application associated with, and accessible to, a mobile device. The mobile device may be associated with a user of the mobile device.

The mobile device may include near-field communication (“NFC”) capabilities. NFC capabilities may enable the transmitting and receiving of the electronic communications between the mobile device and the POS.

In some embodiments, the mobile device may generate a token for each transaction. The token may be valid (and in some embodiments required) for a single transaction. This may be an additional layer of authentication when using the mobile device to perform a transaction.

Additionally, in response to generation of an alert associated with the mobile device, the issuer may deactivate any digital card that is associated with the mobile device.

In some embodiments, the mobile device may include a payment interface to resolve different payment options to different secure payment gateways.

In some embodiments, the mobile device may include a reverse payment initiator that may be configured to request a payment amount from a contact bank account and contact mobile device and send payment instructions to a payment gateway.

The mobile device may include hardware and associated integrated circuitry for users to complete online payments without entering sensitive transaction information into a third-party system such as a web browser or other software applications. The mobile device may include a touch-sensitive screen. The mobile device may include a virtual keypad. The user may depress keys on the keypad or use the touch-sensitive screen to enter information directly into the mobile device.

The mobile device may include various other hardware components. Such components may include a speaker, and antenna(s). The mobile device may include RAM, ROM, an input/output (“I/O”) module and a non-transitory or non-volatile memory.

The I/O module may include a microphone which may accept user provided input. The I/O module may include one or more of a speaker for providing audio output and a display for providing textual, audiovisual and/or graphical output.

Software may be stored within the non-transitory memory and/or other storage media. Software may provide instructions that when executed by the microprocessor, enable the mobile device to perform various functions. For example, software may include an operating system, application programs, web browser and a database. Alternatively, some or all of computer executable instructions of the mobile device may be embodied in hardware or firmware components of the mobile device. Application programs, which may be used by the mobile device, may include computer executable instructions for invoking user functionality related to communication, authentication services, and voice input and speech recognition applications.

Application programs may utilize one or more algorithms that encrypt information, process received executable instructions, interact with an issuer or acquirer bank systems, perform power management routines or other suitable tasks.

The mobile device may operate in a networked environment. The mobile device may support establishing communication channels with one or more issuer or acquirer bank systems. The mobile device may connect to a local area network (“LAN”), a wide area network (“WAN”) a cellular network or any suitable communication network. When used in a LAN networking environment, the mobile device may be connected to the LAN through a network interface or adapter. The Network Interface Card (“NIC”) may include the network interface or adapter.

When used in a WAN networking environment, the mobile device may include a modem or other means for establishing communications over a WAN, such as the Internet. The NIC may include the modem. It will be appreciated that the existence of any of various well-known protocols such as TCP/IP, Ethernet, FTP, HTTP and the like is presumed.

The mobile device may be operational with numerous other general purpose or special purpose computing system environments or configurations. Examples of well-known computing systems, environments, and/or configurations that may be suitable for use with the invention include, but are not limited to, other mobile devices, personal computers, server computers, hand-held or laptop devices, tablets, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like. The mobile device may utilize computer-executable instructions, such as program modules, being executed by a computer. Generally, program modules include routines, programs, objects, components, data structures, etc. that perform particular tasks or implement particular abstract data types. The mobile device may be operational with distributed computing environments where tasks are performed by remote processing devices that are linked through a communications network. In a distributed computing environment, program modules may be located in both local and remote computer storage media including memory storage devices.

Illustrative embodiments of apparatus and methods in accordance with the principles of the invention will now be described with reference to the accompanying drawings, which form a part hereof. It is to be understood that other embodiments may be utilized, and structural, functional and procedural modifications may be made without departing from the scope and spirit of the present invention.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

Apparatus and methods described herein are illustrative. Apparatus and methods of the invention may involve some or all of the features of the illustrative apparatus and/or some or all of the steps of the illustrative methods. The steps of the methods may be performed in an order other than the order shown or described herein. Some embodiments may omit steps shown or described in connection with the illustrative methods. Some embodiments may include steps that are not shown or described in connection with the illustrative methods, but rather shown or described in a different portion of the specification.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

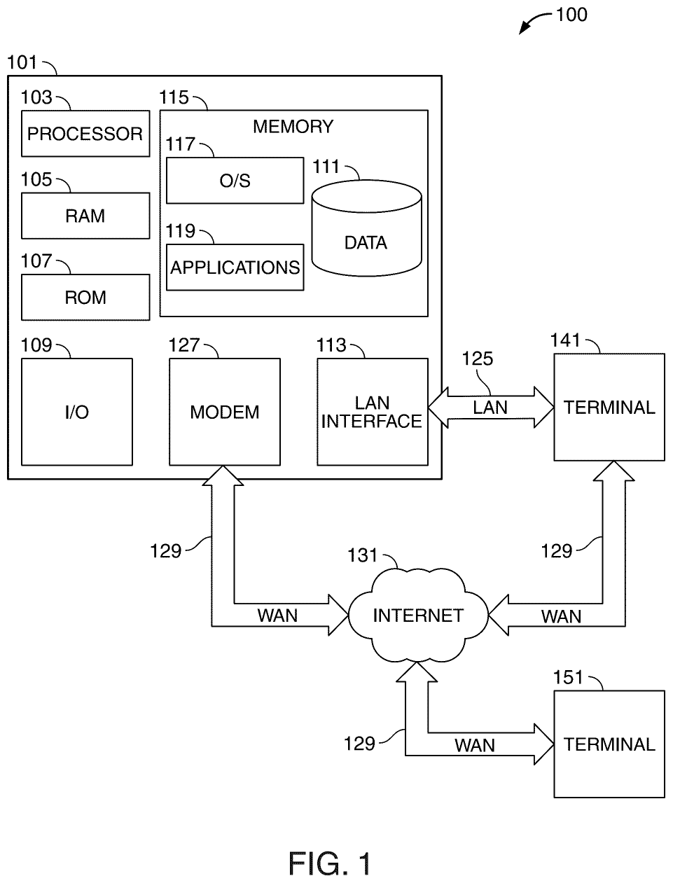

FIG. 1 shows an illustrative block diagram of system 100 that includes computer 101. Computer 101 may alternatively be referred to herein as an “engine,” “server” or a “computing device.”The computing system may include one or more computer servers 101. Computer 101 may be any computing device described herein, such as the smart card, the POS device, the mobile device and one or more servers associated with the issuer and the financial institution. Elements of system 100, including computer 101, may be used to implement various aspects of the systems and methods disclosed herein.

Computer 101 may have a processor 103 for controlling the operation of the device and its associated components, and may include RAM 105, ROM 107, input/output circuit 109, and a non-transitory or non-volatile memory 115. Machine-readable memory may be configured to store information in machine-readable data structures. Other components commonly used for computers, such as EEPROM or Flash memory or any other suitable components, may also be part of the computer 101.

The memory 115 may be comprised of any suitable permanent storage technology—e.g., a hard drive. The memory 115 may store software including the operating system 117 and application(s) 119 along with any data 111 needed for the operation of computer 101. Memory 115 may also store videos, text, and/or audio assistance files. The data stored in Memory 115 may also be stored in cache memory, or any other suitable memory.

Input/output (“I/O”) module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

Computer 101 may be connected to other systems via a local area network (LAN) interface 113. Computer 101 may operate in a networked environment supporting connections to one or more remote computers, such as terminals 141 and 151. Terminals 141 and 151 may be personal computers or servers that include many or all of the elements described above relative to computer 101.

When used in a LAN networking environment, computer 101 is connected to LAN 125 through a LAN interface 113 or an adapter. When used in a WAN networking environment, computer 101 may include a modem 127 or other means for establishing communications over WAN 129, such as Internet 131.

In some embodiments, computer 101 may be connected to one or more other systems via a short-range communication network (not shown). In these embodiments, computer 101 may communicate with one or more other terminals 141 and 151, using a PAN such as Bluetooth®, NFC, ZigBee, or any other suitable personal area network.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or API. Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application programs 119 may utilize one or more algorithms that process received executable instructions, perform power management routines or other suitable tasks. Application programs 119 may include any one or more of the applications, instructions and algorithms associated with and/or embedded within the smart card, a POS device, a mobile device, and any other applications described herein.

Application program(s) 119 may include computer executable instructions (alternatively referred to as “programs”). The computer executable instructions may be embodied in hardware or firmware (not shown). The computer 101 may execute the instructions embodied by the application program(s) 119 to perform various functions.

Application program(s) 119 may utilize the computer-executable instructions executed by a processor. Generally, programs include routines, programs, objects, components, data structures, etc. that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

One or more of applications 119 may include one or more algorithms that may be used to implement features of the disclosure. Applications 119 may include one or more applications running at the TDU, the SOTAS, the servers of the issuer and/or financial institution and any other application described herein.

The invention may be described in the context of computer-executable instructions, such as applications 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a mobile device.

Terminal 151 and/or terminal 141 may be portable devices such as a laptop, cell phone, Blackberry™, tablet, smartphone, or any other computing system for receiving, storing, transmitting and/or displaying relevant information. Terminal 151 and/or terminal 141 may be one or more user devices. Terminals 151 and 141 may be identical to computer 101 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, and/or smart phones, multiprocessor systems, microprocessor-based systems, cloud-based systems, programmable consumer electronics, network PCs, minicomputers, mainframe computers, distributed computing environments that include any of the above systems or devices, and the like.

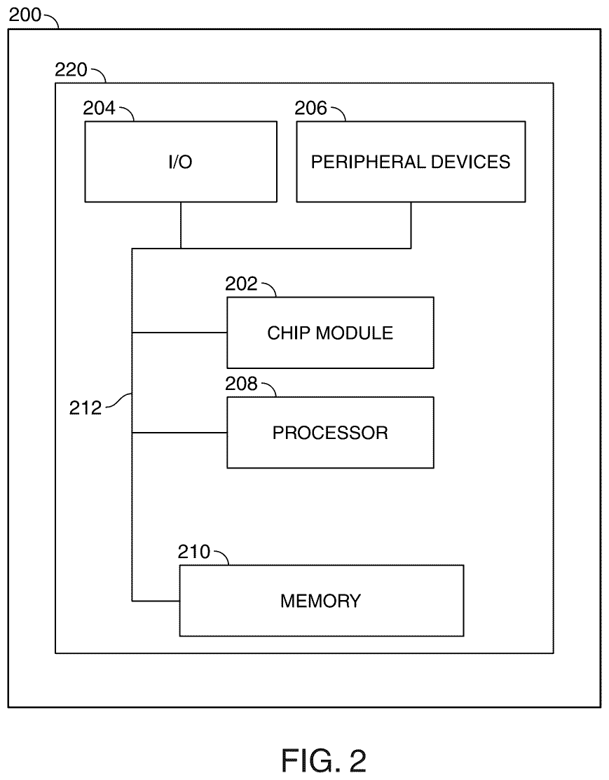

FIG. 2 shows illustrative apparatus 200 that may be configured in accordance with the principles of the disclosure. Apparatus 200 may be a computing device. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 119, signals, and/or any other suitable information or data structures.

Components 202, 204, 206, 208 and 210 may be coupled together by a system bus or other interconnections 212 and may be present on one or more circuit boards such as circuit board 220. In some embodiments, the components may be integrated into a single chip. The chip may be silicon-based.

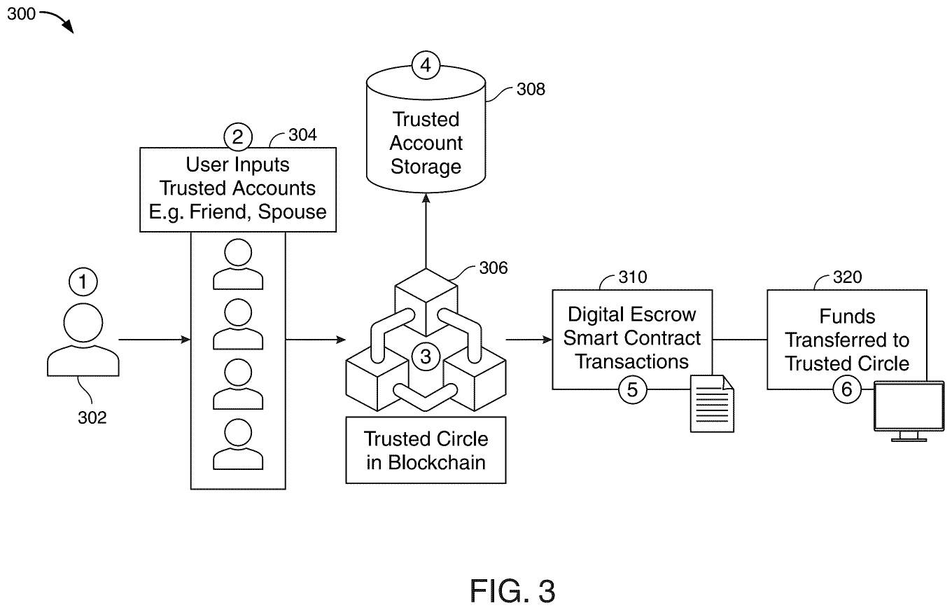

FIG. 3 shows an illustrative flow diagram 300 in accordance with principles of the disclosure. The illustrative flow diagram 300 involves trusted transaction partners.

In the flow diagram 300, user 302 is shown—at (1). User 302 may preferably input one or more trusted account identifiers, as shown at 304—at (2). Such trusted account identifiers may identify such trusted entities as friends, spouses, children, etc.

At 306, an illustration of a trusted circle of the trusted account identifiers is shown—at (3). Such trusted account identifiers may be stored—at (4)—in a trusted account storage, as shown at 308. Transactions that involve a digital escrow, for maintaining control of transacted funds pending the completion of a transaction, and that are supported by a smart contract, are shown at 310—at (5).

Finally, following the satisfaction of the terms of the digital contract and pursuant to the terms set forth therein,—at (6), digitally escrowed funds may be transferred to the member(s) of the trusted circle to whom the funds were intended.

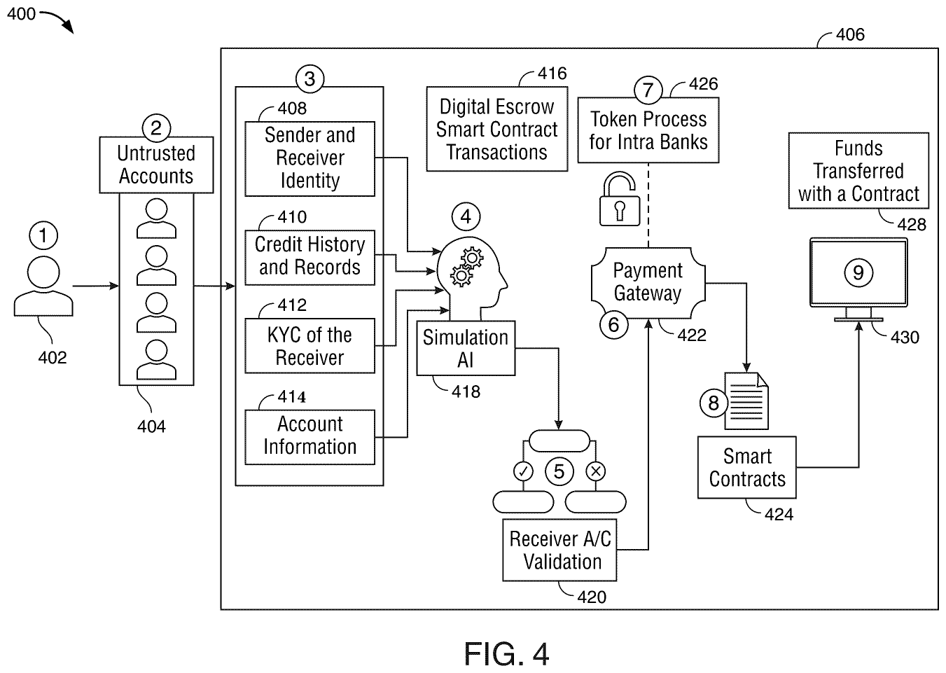

FIG. 4 shows another illustrative flow diagram according to the principles of the disclosure. The illustrative flow diagram 400 involves untrusted transaction partners, as shown at 404—at (2). The systems and methods for implementing treatment for untrusted accounts are shown in the exemplary system enclosed by frame 406.

Information related to the untrusted accounts may be derived—at (3)—based on sender and receiver identify as shown at 408, credit history and records 410, know your customer (KYC) 412 of the receiver, and the respective account information of all the parties as shown at 414.

At (4), shown at 418, AI may be leveraged to simulate the transaction in a non-production environment. As such, the previously undiscovered elements of the AI transaction can preferably be revealed without implicating any real-world change.

At (5), indication of receiver validation/non-validation 420 is shown. Following successful validation, at (6), a payment gateway can be invoked. This is shown at 422.

In a first branch from payment gateway 422, a token process for intra-entities such as banks or other financial institutions (FIs)—i.e., entities with whom a high-trust-level relationship is formed and established—may be invoked.

Such a token process may involve retrieving personal information of the sender and receiver's account, requesting user permission to encrypt the personal information, encrypting the customer's name, account, phone number, and creditability of receiver's account etc., as a token. The app enables transactions based on two parties by establishing the trusted and/or tokenized transaction between inter- and intra-banks or other FIs involved with the users.

In an exemplary transaction, a sender's account is in Bank of America® and recipient's account is in JP Morgan Bank®. Sender can validate the receiver's personal information via a shared tokenization method established between trusted banks like Bank of America®and JP Morgan®.

On an alternative branch of the illustrative flow diagram 400, payment gateway 422 is coupled to smart contracts 424. At smart contracts 424, funds can be transferred pursuant to the terms of a smart contract 428. Such a smart contract may be coded into a block chain (not shown in FIG. 4). In such a smart contract, the app may receive permission from the user to ensure transaction security. Based on the user action, the app may channel the transaction through digital escrow. The digital escrow may provide a substantially immutable system, by holding the funds in digital escrow prior to effectuating the transacting, which can help to protect the whole transaction from fraudsters.

FIG. 5 shows an illustrative set diagram 500 in accordance with principles of the disclosure. In one exemplary embodiment, set diagram 500 illustrates an exemplary set embodiment that may be used by the embodiments to define trusted relationships.

For example, B 504 may present a visual indicator that B 504 is in the most trusted group for A 502 but A 502 is not in the most trusted group for B 504.

C 506 is in the most trusted group for B 504, and the less trusted group for A 502.

D 508 is in the less trusted group of B 504 and not in any trusted group of A 502.

With respect to the foregoing exemplary relationships, embodiments of systems and methods according to the invention may designate certain defined levels of trust for implication of various levels of security measures involving transaction execution. These defined levels of trust preferably relate only to members who share some level of trust but may not relate to members that share no trust—i.e., are untrusted, and, therefore, not members.

For example, only the highest level of trusted entities may be allowed to serve as a recipient of a transaction absent any, except rudimentary, security measures. A second level of trust may implicate one or more security measures. A third level of trust may indicate yet more security measures.

Thus, systems and methods for implementing transaction reversals through artificial intelligence (AI) simulations based on set theoretic properties are provided. Persons skilled in the art will appreciate that the present invention can be practiced by other than the described embodiments, which are presented for purposes of illustration rather than of limitation.

What is claimed is:

1. A method for implementing transaction reversals through one or more artificial intelligence (AI) simulations of a user-specified transaction based on set theoretic properties, the method being implemented on a computer system having a processor and a memory, the method comprising:
receiving, using the processor, a request to perform the user-specified transaction from a user, said user request comprising a user identification of a target recipient account;
receiving, using the processor, a user specification of the user-specified transaction, said user-specified transaction involving the user and the target recipient account as well as a designation of a service to be provided by the target recipient;
deriving, using the processor, identification information from the user-specified transaction, said identification information comprising user identity, recipient identity, and recipient know-your-customer (KYC) information;
leveraging, using the processor, the AI simulation of the user-specified transaction by:
when the simulation of the user-specified transaction obtains greater than a threshold of trust shared between the user and the recipient, validating by the AI, using the processor, the transaction and forwarding the transaction to a payment gateway, and, upon confirmation of performance of the service to be provided by the target recipient, using the payment gateway to perform the user-specified transaction; and
rerouting the user-specified transaction from the payment gateway for transaction denial, and alerting the user and the target recipient to the transaction denial, when the service to be provided by the target recipient is not confirmed as having been performed within a pre-determined amount of time.

2. The method of claim 1 further comprising: when the simulation of the user-specified transaction obtains less than the threshold of trust shared between the user and the recipient, adding, using the processor, an added level of security to be performed prior to forwarding the user-specified transaction to the payment gateway, said added level of security requiring storing the user-specified transaction in an immutable system pending satisfaction of the added level of security by the recipient.

3. The method of claim 1 further comprising:
formulating, using the processor, a token corresponding to the user-specified transaction;
leveraging, using the processor, the token to execute the transaction between a financial institution (FI) associated with the user and an FI associated with the target recipient absent any additional security measures.

4. The method of claim 1, wherein the pre-determined amount of time is 30 minutes.

5. The method of claim 1 further comprising using the payment gateway to perform the user-specified transaction pursuant to a plurality of terms set forth in a smart contract, said smart contract being stored in a blockchain.

6. The method of claim 1, when the simulation of the user-specified transaction obtains a threshold of trust that is non-zero but less than a sufficient threshold of trust sufficient to validate the user-specified transaction, requiring,, using the processor, satisfaction of an additional level of security prior to forwarding the user-specified transaction to the payment gateway, said additional level of security comprising retrieving credit history for the target recipient.

7. The method of claim 1, when the simulation of the user-specified transaction obtains a threshold of trust that is non-zero but less than a sufficient threshold of trust sufficient to validate the user-specified transaction, requiring, using the processor, satisfaction of an additional level of security prior to forwarding the user-specified transaction to the payment gateway, said additional level of security comprising retrieving account information for the target recipient.

8. A method for implementing transaction reversals through artificial intelligence (AI) simulations based on set theoretic properties, the method being implemented on a computer system having a processor and a memory, the method comprising:
receiving, from a user, a user request, said user request that comprises a user identification of a plurality of target recipient accounts, each of the plurality of target recipients that comprises a discrete level of trust between the user and each of the target recipient accounts;
receiving a user specification of a user-specified transaction involving the user and at least one of the plurality of target recipient accounts as well as a designation of a service to be provided by the at least one of the plurality of target recipients, the at least one of the plurality of target recipient being auto-selected based on the level of trust associated with the at least one of the plurality of target recipients;
deriving identification information from the user request, said identification information comprising user identity, recipient identity, and recipient know-your-customer (KYC) information;
leveraging AI to perform a simulation of the user-specified transaction;
when the simulation of the user-specified transaction obtains greater than a threshold of trust shared between the user and the recipient, validating the user-specified transaction and forwarding the user-specified transaction to a payment gateway;
upon confirmation of performance of the service to be provided by the target recipient, using the payment gateway to perform the user-specified transaction; and
when the service to be provided by the target recipient is not confirmed as having been performed within a pre-determined amount of time from the performance of the simulation of the user-specified transaction, rerouting the user-specified transaction from the payment gateway for transaction denial, and alerting the user and the at least one of the plurality of target recipients to the transaction denial.

9. The method of claim 8, further comprising, when the simulation of the user-specified transaction obtains less than the threshold of trust shared between the user and the recipient, adding a level of security to be performed prior to forwarding the transaction to the payment gateway, said level of security requiring storing the transaction in an immutable system pending satisfaction of the added level of security by the at least one of the plurality of target recipients.

10. The method of claim 8, further comprising:
formulating a token corresponding to the transaction;
leveraging the token to execute the transaction between a financial institution (FI) associated with the user and an FI associated with the target recipient absent any additional security measures.

11. The method of claim 8, wherein the pre-determined amount of time is 30 minutes.

12. The method of claim 8 further comprising using the payment gateway to perform the user-specified transaction pursuant to a plurality of terms set forth in a smart contract, said smart contract being stored in a blockchain.

13. The method of claim 8, when the simulation of the user-specified transaction obtains a threshold of trust that is non-zero but less than a sufficient threshold of trust sufficient to validate the user-specified transaction, requiring satisfaction of an additional level of security prior to forwarding the user-specified transaction to the payment gateway, said additional level of security comprising retrieving credit history for the at least one of the plurality of target recipients.

14. The method of claim 8, when the simulation of the user-specified transaction obtains a threshold of trust that is non-zero but less than a sufficient threshold of trust sufficient to validate the transaction, requiring satisfaction of an additional level of security prior to forwarding the transaction to the payment gateway, said additional level of security comprising retrieving account information for the at least one of the plurality of target recipients.

15. An artificial intelligence (“AI”) engine for implementing transaction reversals through one or more artificial intelligence (AI) simulations of a user-specified transaction based on set theoretic properties, the AI engine comprising machine executable instructions stored in a non-transitory memory of a computer system and, when executed by a processor on the computer system, implement transaction reversals through one or more artificial intelligence (AI) simulations of a user-specified transaction based on set theoretic properties, the engine comprising:
a receiver for:
receiving, using the processor, a request to perform the user-specified transaction from a user, said user request comprising a user identification of a target recipient account;
receiving, using the processor, a user specification of the user-specified transaction, said user-specified transaction involving the user and the target recipient account;
the processor further configured to:
derive identification information from the user-specified transaction, said identification information comprising user identity, recipient identity, and recipient know-your-customer (KYC) information;
leverage the AI simulation of the user-specified transaction by:
when the simulation of the user-specified transaction obtains greater than a threshold of trust shared between the user and the recipient, validate the transaction and forwarding the transaction to a payment gateway, and, upon use the payment gateway to perform the transaction; and
reroute the user-specified transaction from the payment gateway for transaction denial, and alert the user and the target recipient to the transaction denial, when the threshold of trust has not been obtained.

16. The engine of claim 15 further configured to: when the simulation of the user-specified transaction obtains less than the threshold of trust shared between the user and the recipient, add, using the processor, an added level of security to be performed prior to forwarding the user-specified transaction to the payment gateway, said level of security requiring storing the user-specified transaction in an immutable system pending satisfaction of the added level of security by the recipient.

17. The engine of claim 15 further operational to:
formulate,, using the processor, a token corresponding to the user-specified transaction;
leverage, using the processor, the token to execute the transaction between a financial institution (FI) associated with the user and an FI associated with the target recipient absent any additional security measures.

18. The engine of claim 15 further operable to use the payment gateway to perform the user-specified transaction pursuant to a plurality of terms set forth in a smart contract, said smart contract being stored in a blockchain.

19. The engine of claim 15 further operable to, when the simulation of the user-specified transaction obtains a threshold of trust that is non-zero but less than a sufficient threshold of trust sufficient to validate the user-specified transaction, require, using the processor, satisfaction of an additional level of security prior to forwarding the user-specified transaction to the payment gateway, said additional level of security comprising retrieving credit history for the target recipient.

20. The engine of claim 15 further operable to, when the simulation of the user-specified transaction obtains a threshold of trust that is non-zero but less than a sufficient threshold of trust sufficient to validate the user-specified transaction, require, using the processor, satisfaction of an additional level of security prior to forwarding the user-specified transaction to the payment gateway, said additional level of security comprising retrieving account information for the target recipient.
